(19) United States
(12) Patent Application Publication
(10) Pub. No.: US 2005/0266332 A1
(43) Pub. Date: Dec. 1, 2005

(54) Oil-free process for full color digital printing

(76) Inventors: Joseph A. Pavlisko, Pittsford, NY (US); Jiann-Hsing Chen, Fairport, NY (US); Dinesh Tyagi, Fairport, NY (US); Muhammed Aslam, Rochester, NY (US)

Correspondence Address: Mark G. Bocchetti;Patent Legal Staff, Eastman Kodak Companny, 343 State Street, Rochester, NY, 14650-2201, US

(21) Appl. No.: 10/857,460

(22) Filed: May 28, 2004

(51) Int. Cl. G03G 15/20

(52) U.S. Cl. 430/124

(57) ABSTRACT

An oil-free process for forming a fused toner image on a receiver includes forming on a receiver, an image including toner particles that contain a non-crosslinked linear polymeric binder, a wax, and a colorant; and contacting the receiver bearing the toner particle image with a fuser member containing a support, a cushion layer overlying the support, and a release layer overlying the cushion layer. The release layer includes a cured fluorocarbon thermoplastic random copolymer, a cured aminosiloxane copolymer, and a zinc oxide particulate filler. The cured fluorocarbon thermoplastics random copolymer contains —(CH₂CF₂)ₓ—, —(CF₂CF(CF₃)_{y}—, and —(CF₂CF₂)_{z}— subunits, wherein x is from 1 to 40 or 60 to 80 mole percent, y is from 10 to 90 mole percent, z is from 10 to 90 mole percent, and x+y+z equals 100 mole percent. The receiver in contact with the fuser member is subjected to conditions effective in the absence of a release oil for fixing the toner particle image to the receiver.

### FIELD OF THE INVENTION

The present invention relates in general to electrostatographic imaging and, in particular, to the fusing of toner images. More specifically, this invention relates to a process for oil-free full color digital printing.

### BACKGROUND OF THE INVENTION

Heat-softenable toners are widely used in imaging methods such as electrostatography, wherein electrically charged toner is deposited imagewise on a dielectric or photoconductive element bearing an electrostatic latent image. In such methods, the toner is then generally transferred to a surface of another substrate, such as, for example, a receiver sheet including paper or a transparent film, where it is fixed in place to yield the final desired toner image.

When heat-softenable toners including, for example, thermoplastic polymeric binders, are employed, the usual method of fixing the toner in place involves applying heat to soften the toner that has been transferred to the receiver sheet surface, then allowing or causing the toner to cool.

One well-known fusing method entails passing the toner-bearing receiver sheet through the nip formed by a pair of opposing rolls, a heated roller, usually referred to as a fuser roller, that contacts the toner-bearing surface of the receiver sheet in order to heat and soften the toner. The other roller, usually referred to as a pressure roller, serves to press the receiver sheet into contact with the fuser roller. In some other fusing methods, the configuration is varied, with a flat plate or belt replacing the fuser roller and/or pressure roller. The description herein, while generally directed to a generally cylindrical fuser roller in combination with a generally cylindrical pressure roller, is not limited to fusing systems having members with those configurations. For that reason, the terms “fuser member” and “pressure member” are generally used herein in place of “fuser roller” and “pressure roller”.

In an electrophotographic copying process, the electrostatic latent image formed on a photoconductive surface is developed with a developer that is a mixture of magnetic carrier particles, together with a thermoplastic toner powder that is thereafter fused to a receiver such as a sheet of paper. The fusing step typically consists of passing the sheet of paper on which toner powder is distributed in an imagewise pattern through the nip of a pair of rolls that include the fuser member and the pressure member. Where the fusing member is a belt, it is preferably a flexible endless belt that passes around a heated roller and has a smooth, hardened outer surface.

During the fusing operation, when the toner is heated while in contact with the fuser member, it may adhere not only to the paper receiver but also to the fuser member. Any toner remaining adhered to the fuser member can cause a false offset image to appear on the next sheet while also degrading the fuser member. Other potential problems are thermal degradation and abrasion of the fuser member surface, resulting in an uneven surface and defective patterns in thermally fixed images.

Toner fusing rolls have a cylindrical core that may contain a heat source in its interior, and a resilient covering layer formed directly or indirectly on the surface of the core. Roll coverings are commonly fluorocarbon polymers or silicone polymers, such as poly(dimethylsiloxane) polymers of low surface energy, which minimizes adherence of toner to the roll. Frequently release oils composed of, for example, poly(dimethylsiloxanes), are also applied to the roll surface to prevent adherence of toner to the roll. Such release oils, however, may interact with the roll surface upon repeated use and in time cause swelling, softening, and degradation of the roll. Silicone rubber covering layers that are insufficiently resistant to release oils and cleaning solvents are also susceptible to delamination of the roll cover after repeated heating and cooling cycles.

Fusing members with a surface coating of a fluoroelastomer, especially vinylidene fluoride based fluoroelastomers, possess excellent heat, oil and chemical resistance as well as good fatigue and wear characteristics. Despite these desirable properties, they have a propensity to interact with toners, especially those formulated from polyesters, causing premature offsets.

U.S. Pat. No. 4,264,181 discloses fusing members coated with a metal-filled elastomer surface obtained by nucleophilic-addition curing of a mixture of a metal filler and a vinylidene fluoride-hexafluoropropylene copolymer. The surface coatings disclosed are used in conjunction with functionally substituted polymeric release agents capable of interacting with the metal component.

The fuser member usually includes a rigid core and a layer of resilient material, referred to as a “base cushion layer”, disposed between the core and the surface layer. The base cushion layer and the amount of pressure exerted by the pressure member serve to establish the area of contact of the fuser member with the toner-bearing surface of the receiver sheet as it passes through the nip of the fuser member and pressure member. The size of this area of contact helps to establish the length of time that any given portion of the toner image will be in contact with and heated by the fuser member. The degree of hardness, often expressed as “storage modulus”, and the stability of the base cushion layer are important factors in establishing and maintaining the desired area of contact.

Polysiloxane elastomers have relatively high surface energy and relatively low mechanical strength, but are adequately flexible and elastic and can produce high quality fused images. After a period of use, however, the self release property of the roller degrades and offset begins to occur. Application of a polysiloxane fluid during roller use enhances the ability of the roller to release toner, but shortens roller life due to oil absorption. Oiled portions tend to swell and wear and degrade faster.

Polyfluocarbon elastomers, such as vinylidene fluoride-hexafluoropropylene copolymers, are tough, wear resistant and flexible elastomers that have excellent high temperature resistance, but relatively high surface energies, which compromises toner release.

Fluorocarbon resins such as polytetrafluoroethylene (PTFE) or fluorinated ethylenepropylene (FEP) are fluorocarbon plastics that have excellent release characteristics due to very low surface energy. However these resins, being less flexible and elastic than fluorocarbon elastomers, are not suitable for the surface of the fuser roller when used alone.

U.S. Pat. No. 4,568,275 discloses a fuser roll having a layer of fluorocarbon elastomer and a fluorinated resin powder. However, the fluorocarbon elastomer that is disclosed is water dispersible and it is known that the mixture phase separates on coating so that the fluorinated resin that is used comes to the surface of the layer.

U.S. Pat. No. 5,253,027 discloses a fluorinated resin in a silicone elastomer. However, composites of this type exhibit unacceptable swell in the presence of silicone release oil.

U.S. Pat. No. 5,599,631 discloses a fuser roll having a layer of a fluorocarbon elastomer and a fluorocarbon resin. The drawback of this type of material is that the fluorocarbon resin powder tends to phase separate from the fluorocarbon elastomer, thereby diminishing toner release.

U.S. Pat. No. 4,853,737 discloses a fuser roll having an outer layer including cured fluorocarbon elastomers containing pendant amine functional polydimethylsiloxanes that are covalently bonded to the backbone of the fluorocarbon elastomer. However, the amine functional polydimethylsiloxane tends to phase separate from the fluorocarbon elastomer.

U.S. Pat. No. 5,582,917 discloses a fuser roll having a surface layer including a fluorocarbon-silicone polymeric composition obtained by heating a fluorocarbon elastomer with a fluorocarbon elastomer curing agent in the presence of a curable polyfunctional poly(C₁₋₆ alkyl) siloxane polymer. However, the resulting interpenetrating network (IPN) has relatively high coefficient of friction and relatively low mechanical strength. After a period of use, the release property of the roller degrades, and paper jams begin to occur.

U.S. Pat. No. 5,547,759 discloses a fuser roll having a release coating layer including an outermost layer of fluorocarbon resin uniquely bonded to a fluoroelastomer layer by means of a fluoropolymer containing a polyamide-imide primer layer. Although the release coating layer has relatively low surface energy and good mechanical strength the release coating layer lacks flexibility and elastic properties and can not produce high quality of images. In addition, sintering the fluorocarbon resin layer is usually accomplished by heating the coated fuser member to temperatures of approximately 350° C. to 400° C. Such high temperatures can have a detrimental effect on the underlying base cushion layer, which normally includes a silicone rubber layer. It would be desirable to provide a fuser member with an overcoat layer including a fluorocarbon resin layer without depolymerizing the silicone base cushion layer.

U.S. Pat. No. 6,127,041 discloses a fuser member that has a metallic core on which is coated a composite layer including a silicone T-resin, a crosslinked poly(dialkylsiloxane) incorporating an oxide, and a silane crosslinking agent. The oxide in the composite layer of the fuser member can be an oxide or a mixture of oxides, aluminum oxide, iron oxide, tin oxide, zinc oxide, copper oxide, nickel oxide, and silica being listed in the reference as typical oxides.

U.S. Pat. No. 5,017,432 discloses a fuser member having a fusing surface that includes VITON GF®, poly(vinylidene fluoride-hexafluoropropylene-tetrafluoroethylene), that has been cured with a nucleophilic curing agent.

U.S. Pat. No. 5,595,823 discloses toner fusing members that have a substrate coated with a fluorocarbon random copolymer containing aluminum oxide. These toner fusing members have desirable thermal conductivity but may present a problem of toner contamination. Thermoplastic random copolymer compositions can, however be effectively used with silicone-containing toner release agents.

U.S. Pat. No. 4,360,566, which discloses a heat fixing roll whose outer layer is made of a silicone rubber containing substantial amounts of a siliceous filler such as surface treated silica. It is asserted that the disclosed fixing roll does not require impregnation with a silicone release oil to increase significantly the number of copies until offset.

U.S. Pat. No. 6,419,615 discloses a toner fuser roller having an overcoat release layer formed from a cured fluorocarbon thermoplastic random copolymer containing an electrically conductive fine powder in sufficient quantity to make the overcoat layer cross the percolation threshold and become electrically conductive.

U.S. Pat. No. 6,696,158 discloses a fuser member having an overcoat release layer formed from a composition containing a fluorocarbon thermoplastic random copolymer, a curing agent having a bisphenol residue, a particulate filler containing zinc oxide, and an aminosiloxane.

Condensation-crosslinked siloxane elastomers have been widely employed in the past to form resilient base cushion layers for fuser rolls. Disclosure of filled condensation-cured poly(dimethylsiloxane) (PDMS) elastomers for fuser rolls can be found, for example, in U.S. Pat. Nos. 4,373,239, 4,430,406, and 4,518,655. U.S. Pat. No. 4,970,098 teaches a condensation cross-linked diphenylsiloxane-dimethylsiloxane elastomer having 40 to 55 weight percent zinc oxide, 5 to 10 weight percent graphite, and 1 to 5 weight percent ceric dioxide.

A siloxane elastomer widely used for cushion layers is a condensation-curable PDMS elastomer, which contains about 32-37 volume percent aluminum oxide filler and about 2-6 volume percent iron oxide filler, and is sold under the trade name, EC4952, by Emerson Cuming Inc. Fuser rolls containing EC4952 cushion layers exhibit some stability problems over time of use, but at least over the short term they possess suitable resilience, hardness, and thermal conductivity.

Another type of siloxane elastomer useful for forming cushion layers is an addition-curable PDMS elastomer containing a metal oxide filler and sold under the trade name S5100 by Emerson Cuming Inc. A cushion layer formed from an addition-cured S5100 PDMS elastomer typically has a smoother surface than one made from a condensation-cured ES4952 PDMS elastomer.

Toner particle compositions typically include a binder polymer and a colorant, and frequently also contain a charge control agent. A variety of resins may be employed, but polyesters have been disclosed as especially useful. U.S. Pat. No. 5,330,870 discloses an electrophotographic developer composition containing a polyester binder derived from a phthalic acid component and an alcohol component that is a bisphenol A alkylene oxide adduct. The described compositions are asserted to be useful in flash fusing processes, in which the toner is fused to a receiver by heat from a light source.

U.S. Pat. No. 5,756,244 discloses a toner composition intended for full-color electrophotography that includes a linear polyester binder, a colorant, and a releasing agent including carnauba wax. The compositions are intended to be fixed to a receiver by heat, without the use of a releasing oil.

U.S. Pat. No. 6,326,116 discloses a toner that includes a toner base containing a binder resin, a colorant, and an ester-based wax fixing assistant, together with an inorganic external additive such as silica powder. The compositions are purported to provide good fixability and anti-offset properties in the absence of a releasing oil.

U.S. Pat. No. 5,935,751 discloses a toner for an electrostatic imaging process that includes a binding resin a colorant, and 0.1-40 wt. % of a wax having a number-average dispersion diameter of 0.1-2 μm, 1-10 wt. % of the wax being disposed on the surface of the toner. Also disclosed is a process for forming, developing, and transferring a toner image to a transfer member without the need for a release oil.

U.S. Pat. No. 6,541,173 discloses a toner for a full-color image-forming method that includes a coloring agent, a binder resin including a linear polyester resin and a non-linear polyester resin, a first releasing agent having a softening point of 55-110° C., and a second releasing agent having a softening point of 110-160° C. It is stated that the toner can be fixed using an oil-less fixing roller.

U.S. Pat. No. 6,492,083 discloses toner particulates that include a resin and a release agent that includes no more than 50 wt. % of a polyethylene wax having a number-average molecular weight of no greater than about 10,000 and at least about 50 wt. % of a maleic anhydride ester-functionalized polyethylene as a functionalized enhancing agent.

The disclosures of all of the patents cited in this background section are incorporated herein by reference.

### SUMMARY OF THE INVENTION

The present invention is directed to an oil-free process for forming a fused toner image on a receiver that includes, forming on a receiver an image including toner particles that contain a non-crosslinked linear polymeric binder, a wax and a colorant, and contacting the receiver bearing the toner particle image with a fuser member including a support, a cushion layer overlying the support, and a release layer overlying the cushion layer. The release layer includes a cured fluorocarbon thermoplastic random copolymer, a particulate filler including zinc oxide, and a cured aminosiloxane copolymer, the cured fluorocarbon thermoplastics random copolymer having —(CH₂CF₂)ₓ—, —(CF₂CF(CF₃)_{y}—, and —(CF₂CF₂)_{z}— subunits, wherein x is from 1 to 40 or 60 to 80 mole percent, y is from 10 to 90 mole percent, z is from 10 to 90 mole percent, and x+y+z equals 100 mole percent. The receiver in contact with the fuser member is subjected to conditions effective in the absence of a release oil for fixing the toner particle image to the receiver, thereby forming a fused toner image on the receiver.

### DETAILED DESCRIPTION OF THE INVENTION

A typical fuser member as illustrated, for example, by FIG. 1 of the previously mentioned U.S. Pat. No. 6,696,158, includes a roll support, an intermediate cushion layer that is conformable and disposed over the support, and an outermost toner release layer disposed over the cushion layer. Suitable materials for constructing the support include, for example, aluminum, steel, various alloys, and polymeric materials such as thermoset resins, with or without fiber reinforcement. The roll support, which can be primed prior to formation of the cushion layer, is preferably made from metal. Because the fuser member is employed in an oil-free process, it can be incorporated in a fusing apparatus that lacks a an oil reservoir, wicking device, intermediate roll, and donor roll, which are typically required when a release oil is used.

The toner release layer of the fuser member includes a cured fluorocarbon random copolymer containing subunits of:
—(CH₂CF₂)ₓ—, —(CF₂CF(CF₃)_{y}—, and —(CF₂CF₂)_{z}—,
wherein
x is from 1 to 40 or 60 to 80 mole percent,
y is from 10 to 90 mole percent,
z is from 10 to 90 mole percent, and
x+y+z equals 100 mole percent;
—(CH₂CF₂)— vinylidene fluoride subunit, “VF₂”
—(CF₂CF(CF₃)— hexafluoropropylene subunit, “HFP”
—(CF₂CF₂)— tetrafluoroethylene subunit, “TFE”

The layer, which is cured by, preferably, a bisphenol residue curing agent such as Curative 50, further includes a particulate filler including zinc oxide and tin oxide, and an aminosiloxane copolymer that is preferably an amino functional polydimethylsiloxane copolymer including amino functional units selected from the group consisting of (aminoethylaminopropyl)methyl, (aminopropyl)methyl, and (aminopropyl)dimethyl.

Optionally, the layer may further contain a fluorinated resin selected from the group consisting of polytetrafluoroethylene and fluoroethylenepropylene and having a number average molecular weight of between 50,000 and 50,000,000.

The release layer formed from the fluorocarbon thermoplastic random copolymer, aminosiloxane copolymer, and zinc oxide filler has highly desirable characteristics, including good mechanical strength, excellent toner release, and reduced toner contamination. It is particularly surprising that these fluorocarbon thermoplastic random copolymers, which are known to have low processing temperatures, would yield compositions that have moderately low surface energies and excellent mechanical properties for use in a high temperature fuser member application.

In the formulas shown above, x, y, and z are mole percentages of the individual subunits relative to a total of the three subunits (x+y+z), referred to herein as “subunit mole percentages” (The curing agent can be considered to provide an additional “cure-site subunit”, however, the contribution of these cure-site subunits is not considered in subunit mole percentages.) In the fluorocarbon thermoplastic copolymer, x has a subunit mole percentage of from 1 to 40 or 60 to 80 mole percent, y has a subunit mole percentage of from 10 to 90 mole percent, and z has a subunit mole percentage of from 10 to 90 mole percent. In a currently preferred embodiment of the invention, subunit mole percentages are: x is from 30 to 40 or 70 to 80, y is from 10 to 60, and z is from 5 to 30; or more preferably x is from 35 to 40, y is from 40 to 58, and z is 5 to 10. In the currently preferred embodiments of the invention, x, y, and z are selected such that fluorine atoms represent at least 75 percent of the total formula weight of the VF₂, HFP, and TFE subunits.

Preferably, a curable amino-functional polydimethylsiloxane copolymer is used in the present invention and is cured concurrently with the fluorocarbon thermoplastic random copolymer to produce a coating suitable for use as the toner release layer of a fusing member. In accordance with the invention, coated fusing members have low energy surfaces that release toner images with minimal offset. Preferred curable bis(aminopropyl) terminated polydimethylsiloxane oligomers are available in a series of molecular weights as disclosed, for example, by Yilgor, et al, “Segmented Organosiloxane Copolymer”, Polymer, 1984, Vol. 25, pp. 1800-1806.

Available curable amino functional polydimethylsiloxanes having functional groups such as aminopropyl or aminoethylaminopropyl pendant from the siloxane backbone include, for example, DMS-A11, DMS-A12, DMS-A15, DMS-A21 and DMS-A32, available from Gelest, Inc. and having a number-average molecular weight between about 850 to 27,000. Other curable amino functional polydimethylsiloxanes that can be used are disclosed in U.S. Pat. Nos. 4,853,737 and 5,157,445, the disclosures of which are incorporated herein by reference.

A preferred release layer composition in accordance with the invention has a ratio of amino siloxane copolymer to fluorocarbon thermoplastic random copolymer between about 0.01 and 0.2 to 1 by weight, preferably between about 0.05 and 0.15 to 1. The composition is preferably obtained by curing a mixture including from about 60-90 weight percent of a fluorocarbon thermoplastic copolymer, 5-20 weight percent, most preferably about 5-10 weight percent, of a curable amino functional polydimethyl siloxane copolymer, 1-5 weight percent of bisphenol residue curing agent, 1-20 weight percent of an zinc oxide acid acceptor type filler, and 10-50 weight percent of a fluorinated resin release aid filler.

Curing of the fluorocarbon thermoplastic random copolymer is carried out at much shorter curing cycles compared to the well known conditions for curing vinylidene fluoride-based fluorocarbon elastomer copolymers. For example, the cure of fluorocarbon elastomers is usually for 12-48 hours at temperatures of about 50° C. to about 250° C. Typically, fluorocarbon elastomer coating compositions are dried until solvent free at room temperature, gradually heated to about 230° C. over 24 hours, and then maintained at that temperature for a further 24 hours. By contrast, the cure of the fluorocarbon thermoplastic random copolymer compositions of the current invention is achieved by heating for about 3 hours at a temperature of about 220° C. to about 280° C., and holding for an additional 2 hours at a temperature of about 250° C. to about 270° C.

The outer layer includes a particulate filler including zinc oxide. In a currently preferred embodiment of the invention, the particulate zinc oxide filler has a total concentration in the outer layer of from about 1 part to about 20 parts per hundred parts by weight (pph) of the fluorocarbon thermoplastic random copolymer. Concentrations of zinc oxide less than about 1 pph may not provide the desired degree of stability to the layer. Concentrations of zinc oxide greater than about 20 pph will render the layer too stiff to provide the desired area of contact with the toner-bearing receiver sheet. In a particular embodiment of the invention, the outer layer has about 3 pph to about 10 pph of zinc oxide.

The particle size of the zinc oxide filler does not appear to be critical. Particle sizes anywhere in the range of 0.1 μm to about 100 μm have been found to be acceptable. In the examples presented below, the zinc oxide particles are from about 1 μm to about 40 μm in diameter.

To form the release layer, the filler particles are mixed with the uncured fluorocarbon thermoplastic random copolymer, amino siloxane, a bisphenol residue curing agent, and any other additives, such as fluorinated resin; shaped over the base cushion layer, and cured. The fluorocarbon thermoplastic random copolymer is typically cured by crosslinking with a basic nucleophilic addition curing system, as discussed in, for example, U.S. Pat. No. 4,272,179, the disclosure of which is incorporated herein by reference. Useful curing agents can be derived from diamines or from aromatic polyhydroxy compounds. Commercially available diamine-based curing agents include DIAK No. 1 (hexamethylenediamine carbamate) and DIAK No. 3 (N,N′-dicinnamylidene-1,6-hexanediamine), available from duPont. A useful aromatic polyhydroxy curing agent, also available from duPont, is Cure 50, is derived from bisphenol A and further includes a quaternary salt accelerator, benzyltriphenylphosphonium chloride. The fluorinated resins, which include polyterafluoroethylene (PTFE) or fluoroethylenepropylene (FEP), are available from duPont.

Suitable fluorocarbon thermoplastic random copolymers are available commercially. A particular embodiment of the invention includes a vinylidene fluoride-co-tetrafluoroethylene co-hexafluoropropylene, which can be represented as -(VF)(75) -(TFE) (10) -(HFP)(25)-. This material, available from Hoechst Company under the designation “THV Fluoroplastics”, is referred to herein as “THV”. In another embodiment of the invention, a vinylidene fluoride-co-tetrafluoroethylene-co-hexafluoropropylene, represented as -(VF)(42)- (TFE) (10) -(HFP)(58)-, is available from Minnesota Mining and Manufacturing under the designation “3M THV” and is referred to herein as “THV-200”. Other suitable uncured vinylidene fluoride-cohexafluoropropylenes and vinylidene fluoride-co-tetrafluoroethylene-cohexafluoropropylenes are available, for example, THV-400, THV-500 and THV-300.

In general, THV Fluoroplastics are distinguished from other melt-processable fluoroplastics by a combination of high flexibility and low process temperature. With flexural modulus values between 83 Mpa and 207 Mpa, THV Fluoroplastics are the most flexible of the fluoroplastics.

The molecular weight of the uncured polymer is largely a matter of convenience; however, an excessively large or excessively small molecular weight would create problems, the nature of which are well known to those skilled in the art. In a preferred embodiment of the invention, the uncured polymer has a number average molecular weight in the range of about 100,000 to 200,000.

Formation of a fuser member, which includes a toner release layer formed on a base cushion layer disposed on a support is carried out using the following steps: (a) providing a support; (b) forming a base cushion layer on the support; (c) providing a mixture containing: (i) a fluorocarbon thermoplastic random copolymer having subunits of: —(CH₂CF₂)ₓ—, —(CF₂CF(CF₃)_{y}—, and —(CF₂CF₂)_{z}—, wherein x is from 1 to 40 or 60 to 80 mole percent, y is from 10 to 90 mole percent, z is from 10 to 90 mole percent, x+y+z equals 100 mole percent; (ii) a filler including zinc oxide; (iii) a curable amino functional polydimethylsiloxane copolymer including aminofunctional units selected from the group consisting of (aminoethylaminopropyl)methyl, (aminopropyl)methyl and (aminopropyl)dimethyl; (iv) a bisphenol residue curing agent; and (d) applying the mixture to the base cushion layer and curing the applied mixture to crosslink the fluorocarbon thermoplastic random copolymer.

In cases where it is intended that the fuser member be heated by an internal heater, it is desirable that the outer layer have a relatively high thermal conductivity, so that the heat can be efficiently and quickly transmitted toward the outer surface of the fuser member that will contact the toner intended to be fused. Depending upon relative thickness, it is generally also very desirable for the base cushion layer and any other intervening layers to have a relatively high thermal conductivity.

The thickness and composition of the base cushion and release layers can be chosen so that the base cushion layer provides the desired resilience to the fuser member, and the release layer can flex to conform to that resilience. Usually, the release layer is thinner than the base cushion layer. In accordance with the present invention, the base cushion layer has a thickness of about 1 mm to about 5 mm, and the outer layer has a thickness of about 25 μm to about 100 μm.

Suitable materials for the base cushion layer include any of a wide variety of materials previously used for base cushion layers, such as the condensation cured polydimethylsiloxane marketed as EC4952 by Emerson Cuming. An example of a condensation cured silicon rubber base cushion layer is GE 4044, obtainable from General Electric Co. An example of an addition cured silicone rubber is Silastic J RTV, from Dow Corning, which is applied over a silane primer DC-1200, also obtainable from Dow Corning.

In a particular embodiment of the invention, the base cushion layer is resistant to cyclic stress induced deformation and hardening. Examples of suitable materials to reduce cyclic stress induced deformation and hardening are filled condensation-crosslinked PDMS elastomers, disclosed in U.S. Pat. No. 5,269,740 (copper oxide filler), U.S. Pat. No. 5,292,606 (zinc oxide filler), U.S. Pat. No. 5,292,562 (chromium oxide filler), U.S. Pat. No. 5,480,724 (tin oxide filler), and U.S. Pat. No. 5,336,539 (nickel oxide filler). Additional suitable base cushion layer compositions are disclosed in U.S. Pat. Nos. 5,464,703, 5,466,533 and 5,474,852, the disclosures of which are incorporated herein by reference.

The support of the fuser member, which is usually cylindrical in shape, can be formed from any rigid metal or plastic substance. Because of their generally high thermal conductivity, metals are preferred when the fuser member is to be internally heated. Suitable support materials include, e.g., aluminum, steel, various alloys, and polymeric materials such as thermoset resins, with or without fiber reinforcement. The fuser member is mainly described herein in terms of embodiments in which the fuser member is a fuser roll having a support, a base cushion layer overlying the support, and an outer layer superimposed on the cushion layer. The invention is not, however, limited to a roll, nor is the invention limited to a fusing member having a support bearing only two layers, i.e., the base cushion layer and the outer layer. The fuser member of the invention can have a variety of configurations and layer arrangements known to those skilled in the art.

In accordance with the process of the present invention, toner particles including a noncrosslinked linear polymeric binder, a colorant, and a release agent are fused on a receiver, preferably in the absence of a release oil, using a fuser member that includes a support bearing a release layer including a cured fluorocarbon thermoplastic random copolymer, a cured aminosiloxane copolymer, and a particulate filler of zinc oxide.

Polymeric binders for electrostatographic toners are commonly made by polymerization of selected monomers followed by mixing with various additives and then grinding to a desired size range. During toner manufacturing, the polymeric binder is subjected to melt processing in which the polymer is exposed to moderate to high shearing forces and temperatures in excess of the glass transition temperature of the polymer. The temperature of the polymer melt results, in part, from the frictional forces of the melt processing. The melt processing includes melt-blending of toner addenda into the bulk of the polymer.

The polymer may be made using a limited coalescence reaction such as the suspension polymerization procedure disclosed in U.S. Pat. No. 4,912,009, the disclosure of which is incorporated herein by reference.

Useful binder polymers include vinyl polymers, such as homopolymers and copolymers of styrene. Styrene polymers include those containing 40 to 100 percent by weight of styrene, or styrene homologs, and from 0 to 40 percent by weight of one or more lower alkyl acrylates or methacrylates. Styrene polymers include styrene, alpha-methylstyrene, para-chlorostyrene, and vinyl toluene. Alkyl acrylates or methylacrylates or monocarboxylic acids having a double bond may be selected from acrylic acid, methyl acrylate, 2-ethylhexyl acrylate, 2-ethylhexyl methacrylate, ethyl acrylate, butyl acrylate, dodecyl acrylate, octyl acrylate, phenylacrylate, methylacrylic acid, ethyl methacrylate, butyl methacrylate and octyl methacrylate.

Blends of styrene polymers, for example, styrene butylacrylate and styrene butadiene, are also useful as binders. In such blends, the ratio of styrene butylacrylate to styrene butadiene can be 10:1 to 1:10. Ratios of 5:1 to 1:5 and 7:3 are particularly useful. Other useful materials include blends of styrene butylacrylate and/or butylmethacrylate (30 to 80% styrene) and styrene butadiene (30 to 80% styrene).

Other examples of useful binders include fusible styrene-acrylic copolymers that are covalently lightly crosslinked with a divinyl compound such as divinylbenzene. Binders of this type are described in, for example, U.S. Reissue Patent No. 31,072, the disclosure of which is incorporated herein by reference.

Also useful are condensation polymers such as polyesters and copolyesters of aromatic dicarboxylic acids with one or more aliphatic diols, such as polyesters of isophthalic or terephthalic acid with diols such as ethylene glycol, cyclohexane dimethanol, and bisphenols. Other useful resins include polyester resins, such as by the co-polycondensation polymerization of a carboxylic acid component including a carboxylic acid having two or more valencies, an acid anhydride thereof or a lower alkyl ester thereof (e.g., fumaric acid, maleic acid, maleic anhydride, phthalic acid, terephthalic acid, trimellitic acid, or pyromellitic acid), using as a diol component a bisphenol derivative or a substituted compound thereof. Specific examples that are described in U.S. Pat. Nos. 5,120,631; 4,430,408; and 5,714,295, the disclosures of which are all incorporated herein by reference, include propoxylated bisphenol—A fumarate, such as FINETONE™ 382 ES, available from Reichold Chemicals, formerly ATLAC™ 382 ES from ICI Americas, Inc. Other noncrosslinked linear polyester binders useful as binders include polymers C and TF-90, available from Kao Corporation. The toner particles have a volume-average particle size of, preferably, about 2 μm to about 20 μm, more preferably, about 4 μm to about 10 μm.

The wax included in the toner particles may be a natural wax or a synthetic wax. A preferred wax is a synthetic polyolefin, for example, a low molecular weight polypropylene or polyethylene having a number-average molecular weight of preferably about 100 to about 10,000, more preferably, about 400 to about 3000. Useful commercially available waxes include, for example, VISCOL™ 550P polypropylene, available from Sanyo Chemical Company, and POLYWAX™ 500 polyethylene, available from Baker Petrolite Company.

The wax is included in an amount of, preferably, about 1 wt. % to about 20 wt. %, more preferably, about 2 wt. % to about 10 wt. %, based on the total weight of the toner.

Colorants may be selected from a great variety of known pigments and dyes, preferably those corresponding to the subtractive primary colors of yellow, magenta, and cyan, along with black. Suitable yellow toner colorants include C.I. Pigment Yellow 12, C.I. Pigment 14, C.I. Solvent Yellow 30, and C.I. Solvent Yellow 77, which may be used singly or in combination. Suitable magenta toner colorants include C.I. Pigment Red 122, C.I. Pigment Red 48:2, C.I. Pigment Red 58:2, C.I. Solvent Red 49, and C.I. Solvent Red 52, which may be used singly or in combination. Suitable cyan toner colorants include phthalocyanine, C.I. Pigment Blue 61, C.I. Pigment Blue 15:3, C.I. Pigment Blue 15:4, C.I. Pigment Blue 15:1, C.I. Solvent Blue 69, and C.I. Solvent Blue 23, which may be used singly or in combination. Suitable black toner colorants include carbon blacks, which may be produced by a variety of methods.

The invention is further illustrated by the following examples:

Preparation of Fuser Rolls

A. A cylindrical aluminum core is cleaned with dichloromethane and dried, then primed with a uniform coat of a silicone primer such as GE 4044 primer (available from GE Silicones, Waterford N.Y.), which is then air dried.

A silicone base cushion layer is applied to the primed core, using a silicone mixture prepared by combining in a three-roll mill 100 parts of EC-4952, a hydroxyl-terminated poly(dimethylsiloxane) polymeric base material available from Emerson Cuming Silicones Division of W.R. Grace and Co., Lexington Mass. This base material is believed to contain about 33 weight percent aluminum oxide and iron oxide as thermally conductive fillers and to further include a condensation-crosslinking agent. About 1 part of dibutyltin diacetate catalyst per 300 parts base material is added in accordance with the manufacturer's directions to initiate curing.

The silicone mixture prepared as just described is degassed and blade-coated onto the core by conventional methods. The coated core is maintained at room temperature (25° C.) for about 24 hours, then placed in a convection oven, where the temperature is ramped to 210° C. over a period of 12 hours, followed by holding at 210° C. for 48 hours to complete curing of the silicone. After cooling, the layer is ground to provide a base cushion layer having a thickness of about 5 mm. The condensation-cured cushion layer is then subjected to corona discharge treatment at a power level of 750 watts for 15 minutes at 210° C. The core thus provided with a condensation-crosslinked polysiloxane elastomer is designated Substrate 1.

B. A second cylindrical aluminum core cleaned with dichloromethane and dried is primed with a uniform coat of a metal alkoxide type primer, Dow 1200 RTV, available from Dow Corning Corporation, Midland Mich., then air dried. 100 parts RTV S5100A, an addition-crosslinkable poly(dimethylsiloxane) incorporating an oxide filler, is blended with 100 parts S5100B curing agent, both components being available from Emerson Cuming Silicones Division of W.R. Grace and Co., Lexington Mass. The mixture is degassed and molded on the core to a dried thickness of about 5 mm. The roll is then cured with a 0.5-hour ramp to 80° C., followed by a 1-hour hold at 80° C. The core thus provided with an addition-crosslinked polysiloxane elastomer is designated Substrate 2.

C. 100 parts fluorocarbon thermoplastic random copolymer THV 200A, available from 3M Corporation, 7.44 parts zinc oxide, and 7 parts of a curable aminosiloxane, Cross-linker No. 1, available from Whitford, are mixed with 10 parts fluoroethylenepropylene (FEP), from duPont. The resulting mixture is combined with 2 parts of Curative 50, obtained from duPont, and mixed on a two-roll mill, then dissolved in methyl ethyl ketone to form a 25 weight percent solids solution. Portions of the resulting material are ring coated onto each of the previously described Substrate 1 and Substrate 2, air dried for 16 hours, baked with 2.5-hour ramp to 275° C., given a 30 minute soak at 275° C., then held 2 hours at 260° C., thereby providing, respectively Fuser Roll 1 and Fuser Roll 2, each with a release layer having a thickness of about 50 μm and including a cured fluorocarbon thermoplastic random copolymer and a zinc oxide filler.

Preparation of Pressure Roll

A pressure roll is prepared in a manner similar to that described for Fuser Roll A, except that the formulation contains 9.9 parts zinc oxide and 35.7 parts fluoroethylenepropylene (FEP). Coating and curing of the fluorocarbon thermoplastic random copolymer is carried out as described for Fuser Roll A.

Preparation of Toner Particles

In addition to a binder polymer, a wax, and a colorant, toner particles employed in the process of the present invention further optionally include a small amount, typically about 0.1 to about 5 weight percent based upon the weight of toner, of a charge control agent. The term “charge control” refers to a propensity of a toner addenda to modify the triboelectric charging properties of the resulting toner. A very wide variety of charge control agents for positive charging toners are available. A large but lesser number of charge control agents for negative charging toners are also available. Suitable charge control agents are disclosed in, for example, U.S. Pat. Nos. 3,893,935, 4,079,014, 4,323,634, 4,394,430 and British Patent Nos. 1,501,065 and 1,420,839. Additional useful charge control agents are described in U.S. Pat. Nos. 4,624,907, 4,814,250, 4,840,864, 4,834,920, 4,683,188, 4,780,553 and 4,624,907.

Toner compositions useful for the practice of this invention can be made by melt blending the polymer binder and other materials such as colorants, waxes, and charge control agents in, for example, a two-roll mill or an extruder. The roll milling, extrusion, or other melt processing is performed at a temperature sufficient to achieve a uniformly blended composition. The resulting material, referred to as a “melt product” or “melt slab”, is then cooled. For a polymer having a T_{g} in the range of about 50° C. to about 120° C., or a Tₘ in the range of about 65° C. to about 200° C., a melt blending temperature in the range of about 90° C. to about 240° C. is suitable using a roll mill or extruder. Melt blending times, that is, the exposure period for melt blending at elevated temperature, are in the range of about 1 to about 60 minutes.

The melt product is cooled and then pulverized to a volume average particle size of from about 2 μm to about 20 μm, preferably about 6 μm to about 10 μm. It is generally preferred to first grind the melt product prior to a specific pulverizing operation. The grinding can be carried out by any convenient procedure. For example, the solid composition can be crushed and then ground using, for example, a fluid energy or jet mill, such as described in U.S. Pat. No. 4,089,472, and can then be classified in one or more steps.

The toner composition of this invention can alternatively be made by dissolving the polymer in a solvent in which the wax, colorant, charge control agent and other additives are also dissolved or are dispersed. The resulting solution can then be spray dried to produce particulate toner powders. Methods of this type include limited coalescence polymer suspension procedures, as disclosed in U.S. Pat. No. 4,833,060, which are particularly useful for producing small, uniform toner particles.

The term “particle size,” “size,” or “sized” as used herein in reference to the term “particles”, means the median volume weighted diameter as measured by conventional diameter measuring devices, such as a Coulter Multisizer, sold by Coulter, Inc. of Hialeah, Fla. The median volume weighted diameter is the diameter of an equivalent weight spherical particle which represents the median for a sample.

The classified toner can then be optionally surface treated with fumed silica. R972, a hydrophobic silica manufactured by Nippon Aerosil, may be used. The amount of silica used for surface treatment would range from 0.1 wt. % to 3 wt. % of the toner, depending on the product requirements and the toner particle size. For surface treatment, toner and silica are typically mixed in a 10 liter Henschel mixer with a 4 element impeller for 2 to 30 minutes at 2000 RPM. The silica surface treated toner was sieved through a 230 mesh vibratory sieve to remove undispersed silica agglomerates and any toner flakes that may have formed during the surface treatment process. The temperature during the surface treatment can be controlled to some desired level during the blending operation.

Exemplary Toners 1, 2, 3, and 4 in accordance with the present invention each contain a propoxylated bisphenol A-fumaric acid binder, 4.5 wt. % Pigment Blue 15:3 colorant, 2 wt. % Orient BONTRON™ charge control agent, and varying amounts of a polyolefin wax, as shown in the TABLE below. Comparison Toner C is similarly prepared, except that the wax is omitted. The components are powder blended, melt compounded, ground in an air jet mill, and classified by particle size. The resulting toner particles have a medium average particle size in the range of about 7.8 μm to about 8.5 μm.

Toner Release Test

Toner offset measurements are made using the fuser and pressure rolls prepared as described above. Sample receivers including 1-inch (2.56-cm) squares of paper covered with the various toners are placed in contact with each of the two described Fuser Rolls 1 and 2 of the invention and Comparison Rolls A and B. Each of the comparison rolls includes a cushion layer formed from condensation-cured EC-4952; Comparison Roll A is provided with a TEFLON™ sleeve as release layer, Comparison Roll B with a release layer formed from VITON™ GF elastomer.

Each of the rolls is heated to 350° F. (177° C.), and the pressure roll set for 80 psi is locked in place over the receivers contacting the fuser rolls, thereby forming a nip. Using the wax-containing toners prepared in accordance with the present invention, toner offset is measured for each of the comparison and inventive fuser rolls in the absence of a release oil. Using the comparison toner containing no wax, additional offset measurements are made with the surface of each fuser rolls being treated with an unmeasured amount of NEXPRESS® 2100 amino-functionalized release oil. After 20 minutes, the pressure roll is released from the receivers and fuser roll.

Only a low release force is required to delaminate all of the sample receivers from the fuser rolls. The extent of offset for each example is determined by microscopic examination of the fuser roll surface following delamination. The following numerical evaluation, corresponding to the amount of toner remaining on the fuser roll surface, is employed:

| | | |
|---|---|---|
| 1.0 | 0% | offset |
| 1.1 | 1-2% | offset |
| 1.2 | 3-4% | offset |
| 1.3 | 5-6% | offset |
| 1.4 | 7-8% | offset |
| 1.5 | 9-10% | offset |

The results of the offset measurements are summarized in the following TABLE, the data obtained using the combination of Toners 1, 2, 3, or 4 with Fuser Rolls 1 or 2 being shown in bold face:

### Toner Offset/Release Measurements

91-100% offset

| | | Fuser Roll | | | |
|---|---|---|---|---|---|
| Toner | Wax | A (comparison) | B (comparison) | 1 (invention) | 2 (invention) |
| C (comparison) | None | 1.3 | 1 | 1.05 | 1.05 |
| 1 (invention) | 2.5 wt. % | 1.15 | 1.15 | 1.1 | 1.1 |
| | VISCOL ™ 550P | | | | |
| 2 (invention) | 5 wt. % | 1.25 | 1.2 | 1.05 | 1.05 |
| | VISCOL ™ 550P | | | | |
| 3 (invention) | 2.5 wt. % | 1.4 | 1.1 | 1 | 1 |
| | POLYWAX ™ 500 | | | | |
| 4 (invention) | 5 wt. % | 1.15 | 1.05 | 1.1 | 1.1 |
| | POLYWAX ™ 500 | | | | |

As shown by the measurement results in the TABLE, the use of Fuser Roll 1 or 2 having a release layer formed according to the present invention generally give lower amounts of offset compared with comparison Fuser Rolls A or B having TEFLON™ or elastomeric VITON™ GF release layers. When Fuser Rolls 1 and 2 are combined under oil-free conditions with wax-containing Toners 1, 2, 3, or 4, also formed according to the present invention, further improvement in toner offset results that approach those observed with fusing in the presence of release oil are observed.

The invention has been described in detail with particular reference to certain preferred embodiments thereof, but it will be understood that certain variations and modifications can be effected within the spirit and scope of the invention, which is defined by the claims that follow.

1. A release-oil free process for forming a fused toner image including:
forming an image including toner particles on a receiver, said toner particles including a non-crosslinked linear polymeric binder, a wax, and a colorant;
contacting said receiver bearing said image including toner particles with a fuser member including a support, a cushion layer overlying said support, and a release layer overlying said cushion layer, said release layer including a cured fluorocarbon thermoplastic random copolymer, a cured aminosiloxane copolymer, and a particulate filler including zinc oxide, and said cured fluorocarbon thermoplastic random copolymer having subunits of:
—(CH₂CF₂)ₓ—, —(CF₂CF(CF₃)_{y}—, and —(CF₂CF₂)_{z}—,
wherein
x is from 1 to 40 or 60 to 80 mole percent,
y is from 10 to 90 mole percent,
z is from 10 to 90 mole percent, and
x+y+z equals 100 mole percent; and
subjecting said receiver in contact with said fuser member to conditions effective in the absence of a release oil for fixing said image comprising toner particles to said receiver, thereby forming a fused toner image on said receiver.

2. The process of claim 1, wherein said non-crosslinked linear polymeric binder is selected from the group consisting of polyesters and vinyl addition polymers.

3. The process of claim 1, wherein said polymeric binder is polyester of bis-phenol A.

4. The process of claim 1, wherein said wax is a natural wax or a synthetic wax.

5. The process of claim 4, wherein said wax comprises a low molecular weight polyolefin.

6. The process of claim 4, wherein said wax comprises polypropylene or polyethylene.

7. The process of claim 1, wherein said wax is present in said toner particles in an amount of about 1 wt. % to about 20 wt. %, based on the total weight of said toner.

8. The process of claim 7, wherein said wax is present in said toner particles in an amount of about 2 wt. % to about 10 wt. %, based on the total weight of said toner.

9. The process of claim 1, wherein said wax has a number-average molecular weight of about 100 to about 10,000.

10. The process of claim 9, wherein said wax has a number-average molecular weight of about 400 to about 3000

11. The process of claim 1, wherein said colorant comprises a color selected from the group consisting of black, cyan, yellow, and magenta.

12. The process of claim 10, wherein said colorant is selected from the group consisting of C.I. Pigment Yellow 12, C.I. Pigment 14, C.I. Solvent Yellow 30, C.I. Solvent Yellow 77, C.I. Pigment Red 122, C.I. Pigment Red 48:2, C.I. Pigment Red 58:2, C.I. Solvent Red 49, C.I. Solvent Red 52, copper phthalocyanine, C.I. Pigment Blue 61, C.I. Pigment Blue 15:3, C.I. Pigment Blue 15:4, C.I. Pigment Blue 15:1, C.I. Solvent Blue 69, C.I. Solvent Blue 23, carbon black, and combinations thereof.

13. The process of claim 1, wherein said toner particles further contain a charge control agent.

14. The process of claim 13, wherein said toner particles contain about 0.1 to about 5 weight percent of said charge control agent.

15. The process of claim 1, wherein said toner particles contain about 1 part to about 25 parts release agent per 100 parts of said polymeric binder.

16. The process of claim 1, wherein said toner particles have a volume-average particle size of about 2 μm to about 20 μm.

17. The process of claim 16, wherein said toner particles have a volume-average particle size of about 6 μm to about 10 μm.

18. The process of claim 17, wherein said toner particles have a volume-average particle size of about 7.8 μm to about 8.5 μm.

19. The process of claim 1, wherein said fluorocarbon thermoplastic random copolymer is nucleophilic addition cured.

20. The process of claim 1, wherein said fluorocarbon thermoplastic random copolymer is cured by a curing agent derived from a diamino compound or an aromatic polyhydroxy compound.

21. The process of claim 1, wherein said aminosiloxane copolymer is an amino functional polydimethylsiloxane copolymer.

22. The process of claim 1, wherein said aminosiloxane copolymer has a total concentration in said release layer of from about 1 part to about 20 parts by weight per 100 parts of said fluorocarbon thermoplastic random copolymer.

23. The process of claim 1, wherein said zinc oxide has a total concentration in said release layer of from about 1 part to about 20 parts by weight per 100 parts of said fluorocarbon thermoplastic random copolymer.

24. The process of claim 1, wherein said support is a metal roll.

25. The process of claim 1, wherein said cushion layer comprises a polysiloxane elastomer.

26. The process of claim 25, wherein said cushion layer comprises a condensation-cured PDMS elastomer or an addition-cured PDMS elastomer.

27. The process of claim 1, wherein said cushion layer has a thickness of about 1 mm to about 5 mm, and said release layer has a thickness of about 25 μm to about 100 μm.

28. The process of claim 1, wherein said contacting said receiver bearing said image comprising toner particles with said fuser member is carried out at a nip formed by said fuser member and a pressure member.

29. The process of claim 28, wherein at least one of said fuser and pressure members is heated.

30. The release-oil free process for forming a fused toner image of claim 1, comprising:
forming an image comprising toner particles on a receiver, said toner particles having a volume-average particle size of about 6 μm to about 10 μm and comprising a non-crosslinked linear polymeric binder comprising a polyester of bisphenol A, about 2 wt. % to about 10 wt. %, based on the total weight of said toner, of a polyethylene or polypropylene wax, a colorant, and a charge control agent;
contacting said receiver bearing said image comprising toner particles with a fuser member comprising a metal roll support, a cushion layer comprising an addition-cured PDMS elastomer overlying said support, and a release layer overlying said cushion layer, said release layer comprising a cured fluorocarbon thermoplastic random copolymer, about 1 part to about 20 parts by weight per 100 parts of said fluorocarbon thermoplastic random copolymer of a cured amino functional polydimethylsiloxane copolymer, and about 1 part to about 20 parts by weight per 100 parts of said fluorocarbon thermoplastic random copolymer of a zinc oxide filler, and said cured fluorocarbon thermoplastic random copolymer having subunits of:
—(CH₂CF₂)ₓ—, —(CF₂CF(CF₃)_{y}—, and —(CF₂CF₂)_{z}—,
wherein
x is from 1 to 40 or 60 to 80 mole percent,
y is from 10 to 90 mole percent,
z is from 10 to 90 mole percent, and
x+y+z equals 100 mole percent; and
subjecting said receiver in contact with said fuser member to conditions effective in the absence of a release oil for fixing said image comprising toner particles to said receiver, thereby forming a fused toner image on said receiver.
